(19) United States
(12) Patent Application Publication
(10) Pub. No.: US 2014/0337249 A1
(43) Pub. Date: Nov. 13, 2014

(54) RATINGS FROM COMMUNICATION SESSIONS

(71) Applicant: International Business Machines Corporation, Armonk, NY (US)

(72) Inventors: Judith H. Bank, Morrisville, NC (US); Liam Harpur, Skerries (IE); Ruthie D. Lyle, Durham, NC (US); Patrick J. O'Sullivan, Ballsbridge (IE); Lin Sun, Morrisville, NC (US)

(73) Assignee: International Business Machines Corporation, Armonk, NY (US)

(21) Appl. No.: 13/891,464

(22) Filed: May 10, 2013

(51) Int. Cl. G06Q 30/02

(52) U.S. Cl. CPC G06Q 30/0282
USPC 705/347

(57) ABSTRACT

A method, computer program product, and system is described. An electronic communication session including a first individual and a second individual is identified. A subject matter area associated with the electronic communication session is determined. A first expertise rating of the first individual by the second individual with respect to the subject matter area is received, the first expertise rating being provided in the context of the electronic communication session.

### TECHNICAL FIELD

This disclosure relates to electronic communication.

### BACKGROUND

In various situations, individuals and/or groups of individuals may participate in text-based chat and/or various other electronic communication interactions. For example, in certain instances, multiple individuals may communicate with each other by entering text into a local computing device (e.g., a cell phone, laptop computer, and so on), causing the entered text to be transmitted to computing devices associated with others in the group, and receiving at the local computing device (and/or another device) text that was similarly entered and transmitted based upon inputs from other users. Similarly, for example, individuals may communicate by telephone (including, for example, voice-over IP telephone communication), email, video chat, and so on. Communications of these (and/or other) types may sometimes include discussion of topics for which a level of expertise (and/or other rating or assessment) may be determined.

### BRIEF SUMMARY OF THE DISCLOSURE

According to one aspect of the disclosure, a computer-implemented method includes identifying, by one or more computing devices, an electronic communication session including a first individual and a second individual. The method includes determining, by the one or more computing devices, a subject matter area associated with the electronic communication session. The method includes receiving, by the one or more computing devices, a first expertise rating of the first individual by the second individual with respect to the subject matter area, the first expertise rating being provided in the context of the electronic communication session.

One or more of the following features may be included. The method may include providing a prompt to the second individual to provide the first expertise rating based upon, at least in part, identifying a termination of a portion of the electronic communication session relating to the subject matter area. The subject matter area may be determined based upon, at least in part, semantic analysis of an aspect of the electronic communication session. The subject matter area may be determined based upon, at least in part, identifying one or more topic keywords associated with the electronic communication session. The method may include determining an average expertise rating of the first individual based upon, at least in part, the first expertise rating and one or more additional expertise ratings associated with the subject matter area and the first individual. The average expertise rating may be a weighted average determined based upon, at least in part, weighting the received first expertise rating based upon, at least in part, one or more of an organizational hierarchy, an expertise rating of the second individual with respect to the subject matter area, and a frequency of interaction between the first and second individuals with respect to the subject matter area. The method may include receiving a second expertise rating of the second individual by the first individual with respect to the subject matter area, the second expertise rating being provided in the context of the electronic communication session.

According to another aspect of the disclosure, a computer program product resides on a computer readable storage medium that has a plurality of instructions stored on it. When executed by a processor, the instructions cause a processor to perform operations including. The operations include identifying an electronic communication session including a first individual and a second individual. The operations include determining a subject matter area associated with the electronic communication session. The operations include receiving a first expertise rating of the first individual by the second individual with respect to the subject matter area, the first expertise rating being provided in the context of the electronic communication session.

One or more of the following features may be included. The operations may include providing a prompt to the second individual to provide the first expertise rating based upon, at least in part, identifying a termination of a portion of the electronic communication session relating to the subject matter area. The subject matter area may be determined based upon, at least in part, semantic analysis of an aspect of the electronic communication session. The subject matter area may be determined based upon, at least in part, identifying one or more topic keywords associated with the electronic communication session. The operations may include determining an average expertise rating of the first individual based upon, at least in part, the first expertise rating and one or more additional expertise ratings associated with the subject matter area and the first individual. The average expertise rating may be a weighted average determined based upon, at least in part, weighting the received first expertise rating based upon, at least in part, one or more of an organizational hierarchy, an expertise rating of the second individual with respect to the subject matter area, and a frequency of interaction between the first and second individuals with respect to the subject matter area. The operations may include receiving a second expertise rating of the second individual by the first individual with respect to the subject matter area, the second expertise rating being provided in the context of the electronic communication session.

According to another aspect of the disclosure, a computing system includes one or more processor devices and one or more memory architectures coupled with the one or more processor devices. The one or more processor devices are configured to identify an electronic communication session including a first individual and a second individual. The one or more processor devices are configured to determine a subject matter area associated with the electronic communication session. The one or more processor devices are configured to receive a first expertise rating of the first individual by the second individual with respect to the subject matter area, the first expertise rating being provided in the context of the electronic communication session.

One or more of the following features may be included. The one or more processor devices may be configured to provide a prompt to the second individual to provide the first expertise rating based upon, at least in part, identifying a termination of a portion of the electronic communication session relating to the subject matter area. The subject matter area may be determined based upon, at least in part, one or more of semantic analysis of an aspect of the electronic communication session and identifying one or more topic keywords associated with the electronic communication session. The one or more processor devices may be configured to determine an average expertise rating of the first individual based upon, at least in part, the first expertise rating and one or more additional expertise ratings associated with the subject matter area and the first individual. The average expertise rating may be a weighted average determined based upon, at least in part, weighting the received first expertise rating based upon, at least in part, one or more of an organizational hierarchy, an expertise rating of the second individual with respect to the subject matter area, and a frequency of interaction between the first and second individuals with respect to the subject matter area. The one or more processor devices may be configured to receive a second expertise rating of the second individual by the first individual with respect to the subject matter area, the second expertise rating being provided in the context of the electronic communication session.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a Session-Based Rating process coupled to a distributed computing network;

FIG. 2 is a flowchart of a process executed by the Session-Based Rating process of FIG. 1;

FIG. 3 is a diagrammatic view of an aspect of the Session-Based Rating process of FIG. 1;

FIG. 4 is a diagrammatic view of an aspect of the Session-Based Rating process of FIG. 1.

Like reference symbols in the various drawings indicate like elements.

### DETAILED DESCRIPTION OF THE PREFERRED EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java®, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In various situations, individuals and/or groups of individuals may participate in text-based chat and/or various other electronic communication interactions. For example, in certain instances, individuals may communicate with each other by text-based chat (e.g., using a Text-Based Chat application or process). For example, individuals may enter text into a local computing device (e.g., a cell phone, laptop computer, and so on), cause the entered text to be transmitted to computing devices associated with others in the group, and receive at the local computing device (and/or another device) text that was similarly entered and transmitted based upon inputs from other users. Similarly, for example, individuals may communicate by various other means, including by telephone (including, for example, voice-over IP telephone communication), by email, by video chat, and so on.

Electronic communications of these (and/or other) types may sometimes include discussion (and/or other treatment) of topics for which a level of expertise (and/or other rating or assessment) may be determined. For example, an individual may be working on a particular project and may have a question or issue with respect to a technical (or other) aspect of that project. As such, the individual may wish to obtain technical (or other) assistance from a different individual who may be more knowledgeable or experienced with respect to the particular question or issue. For example, a software engineer working on a particular aspect of a code build may experience an issue with a particular Java® object. (Java is a registered trademark of Oracle Corporation in the United States, other countries, or both.) As such, the engineer may initiate a text-based chat session (or a communication session of another type, such as a telephone conversation, an email exchange, a video chat, and so on) with a co-worker (who may, for example, have advanced experience with respect to Java) in order to seek assistance with (and/or otherwise discuss) the current issue.

In order, for example, to facilitate more efficient provision of such assistance (as well as for various other reasons), it may be useful to establish expertise ratings of particular individuals with respect to particular subject matter. For example, continuing the example above, it may be useful to the software engineer, in selecting a co-worker from whom the engineer may request assistance, to have access to a rating score (or other type of rating) with respect to various co-workers' respective expertise/experience with Java objects (and/or various other relevant subject matter).

A Session-Based Rating (“SBR”) process (or application) may encourage or motivate an individual to follow up after receiving (and/or providing) assistance regarding particular subject matter by indicating an expertise rating (or related information) with respect to the assistance received (or requested). As such, an SBR process may allow relevant information regarding the expertise of a particular individual to be captured with respect to particular subject matter at one or more relevant times. Similarly, in some situations, for example, an SBR process may allow expertise rating to be made within the context of the actual request for (or provision of) assistance (and/or various other technical discussions), so that the individual providing the rating information may be more likely to have an adequate or optimal recollection of the relevant expertise level (or other relevant information). Similarly, by allowing an individual to provide an expertise rating within the context of the actual request for (or provision of) assistance, an SBR process may reduce the likelihood that the individual providing the rating may be discouraged from requesting (and/or providing) expertise rating information based on social, professional, and/or other considerations.

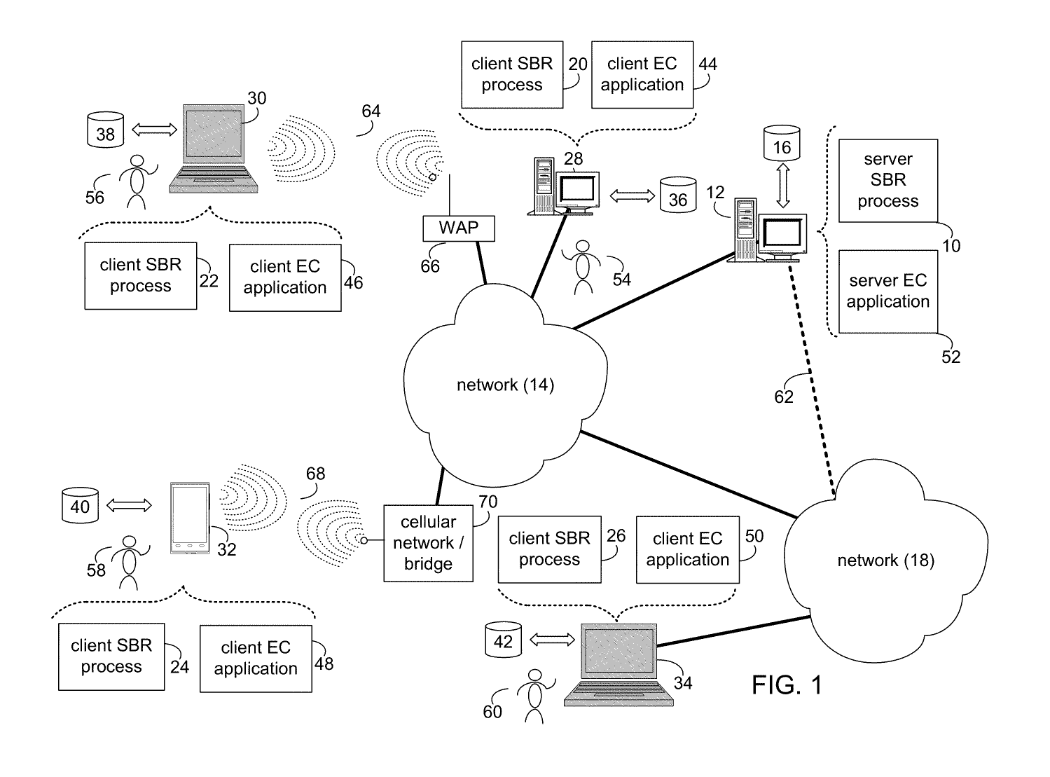

Referring now to FIG. 1, an SBR process may be coupled to a computer or computer network. For example, server SBR process 10 may reside on and may be executed by server computer 12, which may be connected to network 14 (e.g., the Internet or a local area network). Examples of server computer 12 may include, but are not limited to: a personal computer, a server computer, a series of server computers, a mini computer, and/or a mainframe computer. Server computer 12 may be a web server (or a series of servers) running a network operating system, examples of which may include but are not limited to: Microsoft® Windows Server®; Novell® Netware®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.)

The instruction sets and subroutines of server SBR process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft® IIS, Novell® Web Server™, or Apache® Web Server, that allows for access to server computer 12 (via network 14) using one or more protocols, examples of which may include but are not limited to HTTP (i.e., HyperText Transfer Protocol), SIP (i.e., session initiation protocol), and the Lotus® Sametime® VP protocol. (Webserver is a trademark of Novell Corporation in the United States, other countries, or both; Apache is a registered trademarks of Apache Software Foundation in the United States, other countries, or both; Lotus and Sametime are registered trademarks of International Business Machine Corp. in the United States, other countries, or both.) Network 14 may be connected to one or more secondary networks (e.g., network 18), examples of which may include but are not limited to: a local area network; a wide area network; or an intranet, for example.

Client SBR processes 20, 22, 24, 26 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 14 and/or network 18 and may each execute an operating system, examples of which may include but are not limited to Microsoft® Windows®, Microsoft Windows CEO, Red Hat® Linux®, or a custom operating system.

The instruction sets and subroutines of client SBR processes 20, 22, 24, 26, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

In an embodiment, the SBR process may be a server-side process (e.g., which may be implemented via server SBR process 10), in which all of the functionality of the SBR process may be executed on a server computer (e.g., server computer 12). In an embodiment, the SBR process may be a client-side process (e.g., which may be implemented via one or more of client SBR processes 20, 22, 24, 26), in which all of the functionality of the SBR process may be executed on a client computing device (e.g., one or more of client electronic devices 28, 30, 32, 34). In an embodiment, the SBR process may be a hybrid server-client process (e.g., which may be implemented by server SBR process 10 and one or more of client SBR processes 20, 22, 24, 26), in which at least a portion of the functionality of the SBR process may be implemented via server computer 12 and at least a portion of the functionality of the SBR process may be implemented via one or more client computing devices (e.g., one or more of client electronic devices 28, 30, 32, 34).

In certain embodiments, an SBR process may be a stand-alone process. In certain embodiments, an SBR process may operate as part of, or in conjunction with, one or more other processes and/or may include one or more other processes. For example, in certain embodiments, an SBR process may be included in (or may operate in conjunction with) a electronic communication (“EC”) application (or process). An EC application (or process) may be an application (or process) that may facilitate communication among individuals via one or more of a variety of electronic means including phone calls, instant messaging, chat rooms, text messaging, emails, video conferencing, and so on. For example, an EC application may facilitate communication among individuals using telephones (e.g., landlines, cell phones, and so on), various other computing devices (e.g., text input devices, microphones, and so on), and/or other means. Individuals may communicate using an EC application using voice, text, video, and/or various other communication types. In certain embodiments, an EC application may facilitate communication among individuals using protocols such as voice over internet protocols (“VoIP”), which may facilitate voice and/or video communication using internet protocols. In certain embodiments, an EC application (and/or an SBR application) may be part of and/or may interoperate with a social networking application (or process) (not shown), which may provide various types of social networking functionality.

An EC application (or process) may operate (and/or reside) on a client device (e.g., client EC application 44, operating on client electronic device 28; client application EC 46, operating on client electronic device 30; client EC application 48, operating on client electronic device 32; or client EC application 50, operating on client electronic device 34). A client SBR process (e.g., client SBR process 20) or a server SBR process (e.g., server SBR process 10) may be in communication with a client EC application (e.g., client EC application 44) or may be part of a client EC application.

An EC application may additionally/alternatively operate (and/or reside) on a server device (e.g., server EC application 52, operating on server computer 12 or another server EC application (not shown), operating on another server computer (not shown)). A server SBR process (e.g., server SBR process 10) or a client SBR process (e.g., client SBR process 20) may be in communication with a server EC application (e.g., server EC application 52) or may be a part of a server EC application.

Users 54, 56, 58, 60 may access an SBR process in various ways. For example, these users may access server SBR process 10 directly through the device on which a client process (e.g., client SBR processes 20, 22, 24, 26) is executed, namely client electronic devices 28, 30, 32, 34. Users 54, 56, 58, 60 may access server SBR process 10 directly through network 14 and/or through secondary network 18. Further, server computer 12 (i.e., the computer that executes server SBR process 10) may be connected to network 14 through secondary network 18, as illustrated with phantom link line 62. Users 54, 56, 58, 60 may also access a client or server EC application (or process) in similar ways.

The various client electronic devices may be directly or indirectly coupled to network 14 (or network 18). For example, personal computer 28 is shown directly coupled to network 14 via a hardwired network connection. Further, notebook computer 34 is shown directly coupled to secondary network 18 via a hardwired network connection. Laptop computer 30 is shown wirelessly coupled to network 14 via wireless communication channel 64 established between laptop computer 30 and wireless access point (“WAP”) 66, which is shown directly coupled to network 14. WAP 66 may be, for example, an IEEE 802.11a, 802.11b, 802.11g, 802.11n, Wi-Fi, and/or Bluetooth device that is capable of establishing wireless communication channel 64 between laptop computer 30 and WAP 66. Data-enabled mobile telephone 32 is shown wirelessly coupled to network 14 via wireless communication channel 68 established between data-enabled mobile telephone 32 and cellular network/bridge 70, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

For the following discussion, client SBR process 20 will be described for illustrative purposes. It will be understood that client SBR process 20 may, for example, interact and/or communicate with a server SBR process such as server SBR process 10 and/or may be executed within one or more applications that allow for communication with other server and/or client SBR processes. This is not intended to be a limitation of this disclosure, as other configurations are possible (e.g., SBR process 20 may include stand-alone client processes and/or stand-alone server processes). For example, some implementations may include one or more of client SBR processes 22, 24, 26 or server SBR process 10 in place of or in addition to client SBR process 20.

Similarly, many of the examples below may present SBR process 20 functionality in the context of the text-based chat functionality of an EC application and/or SBR process. This is not intended to be a limitation of this disclosure, as other implementations are possible. For example, SBR process functionality may also be implemented with respect to voice communications, email communications, video chat communications, and/or various other types of communications (e.g., as facilitated by various EC applications).

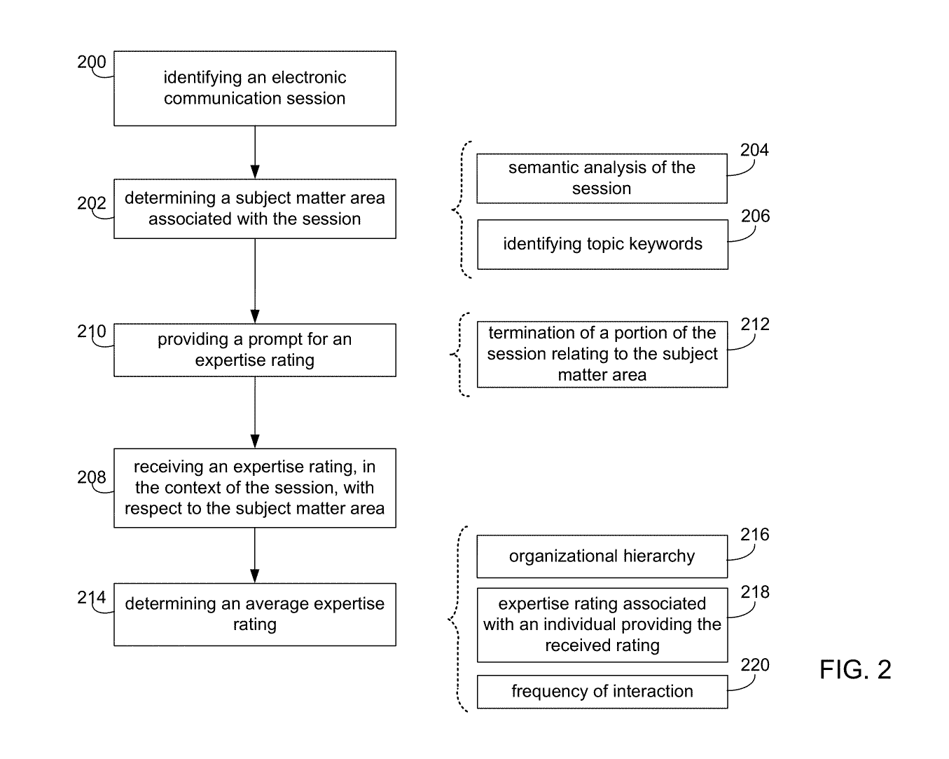

Referring now also to FIG. 2, there is shown a diagrammatic view of an example process that may be implemented by an SBR process, e.g., client SBR process 20. Client SBR process 20 may identify 200 an electronic communication session including a plurality of individuals. As also noted above, an electronic communication session may include various types of electronic communication, such as text-based chat communication, voice communication (e.g., via VoIP systems), email communications, video chat communications, and so on. In certain embodiments, an electronic communication session may include individuals within a single organization and/or individuals spread across multiple organizations. In certain embodiments, electronic communication sessions may occur through or with respect to various social networks or social networking applications.

SBR process 20 may determine 202 a subject matter area associated with the identified 200 electronic communication session. A subject matter area may be relatively general (e.g., software engineering, project management, ceramics, city planning, and so on) and/or may be relatively specific (e.g., implementation of a particular unit text, managing operational budgets for lab improvements, stress characteristics of glass composites, feasibility of congestion fees, and so on). SBR process 20 may determine 202 a subject matter area in a variety of ways. For example, SBR process 20 may perform semantic analysis 204 of an aspect of the relevant communication session, may identify 206 one or more topic keywords associated with the session, and/or may employ various other techniques. In certain embodiments, contextual information such as subject headings, association of a relevant workstation or individual with a particular department or project, association of the communication session with a particular meeting or other calendar event, and so on, may provide information relevant to determining 202 a subject matter area. For example, if a workstation belonging to a ceramics engineer is utilized to initiate a text-based chat session with a manager of the ceramic composites team during a scheduled meeting relating to the “New Glass Products” project, the session having the subject heading “Stress Characteristics?”, SBR process 20 may determine 202 subject matter areas that may include “ceramics,” “ceramic composites,” “non-crystalline ceramics,” “stress characteristics of glass composites,” and so on.

In certain embodiments, SBR process 20 may identify 206 topic keywords from a communication session based upon various topic keywords (and/or other information) being included in a relevant database. For example, an organization may maintain a topic keyword database (e.g., in a storage device 36), which may be accessed by SBR process 20 as part of determining 202 subject matter areas with respect to a particular communication session. Additionally/alternatively, in certain embodiments, SBR process 20 may otherwise receive information relevant to determining 202 a subject matter area. For example, SBR process 20 may utilize directory information (e.g., project team membership, group affiliations, academic degrees or other certifications, and so on) in order to determine 202 subject matter areas, and/or may receive from an individual (e.g., a system administrator, a participant in a relevant communication session, and so on) one or more relevant subject matter areas with respect to a particular individual, group, project and/or communication session.

In certain embodiments, as also noted above, SBR process 20 may utilize semantic analysis 204 of a communication session in order to determine 202 subject matter areas. For example, SBR process 20 may parse the transcript of a text-based chat session in order to identify various questions posed by an initiator of a session (or another session participant) and/or various responses provided by various participants in the session. These may, for example, respectively indicate subject matter areas for which assistance is being sought and/or provided, and which may, accordingly, be relevant to expertise ratings associated with the session and/or various session participants.

In certain embodiments, SBR process 20 may identify one or more transcripts associated with an identified 200 electronic communication session, which may be useful in determining 202 a relevant subject matter area. For example, SBR process 20 may identify a transcript of a text-based chat communication, a transcript representing a series of emails, a voice-to-text transcription of a VoIP communication or landline telephone call, and so on, and may determine 202 a subject matter area associated with a particular communication session based upon analysis of such a transcript.

SBR process 20 may receive 208 an expertise rating of one participant in an identified 200 communication session (the “rated participant”), wherein the rating is provided by another participant (the “rating participant”) with respect to the determined 202 subject matter area. In certain embodiments, the rating participant may be an individual who has received assistance with respect to a particular subject matter area from the rated participant, in which case the received 208 expertise rating may relate, for example, to the assistance provided by the rated participant. In certain embodiments, the rating participant may be an individual who has provided assistance to the rated participant with respect to a particular subject matter area, in which case the received 208 expertise rating may relate, for example, to the questions asked by the rated participant, the type of assistance sought, the ability of the rated participant to understand the assistance offered by the rating participant, and so on.

In certain embodiments (and as also discussed below) SBR process 20 may receive 208 an expertise rating based upon providing a prompt to a participant requesting that the participant provide the rating. In certain embodiments, SBR process 20 may provide such a prompt based upon a variety of factors, including, for example, whether the rating participant has recently provided a rating for the rated participant on the relevant subject matter area. In this way, for example, in certain embodiments SBR process 20 may avoid repetitive (and/or overly-frequent) requests for ratings from a rating participant with respect to particular rated participants. For example, in certain embodiments SBR process 20 may have received 208 an expertise rating yesterday, from a particular individual regarding another individual's expertise in a particular subject matter area. In certain embodiments SBR process 20 may not today prompt the same individual for a rating of the same other individual regarding the same subject matter area, even though the two individuals may have engaged in a communication today regarding that same (or a similar) subject matter area.

In certain embodiments, SBR process 20 may automatically provide a prompt for entry of a rating. In certain embodiments, SBR process 20 may provide a prompt for entry of a rating based upon receiving one or more inputs. For example, in certain embodiments a rating participant may click on a “Provide Rating” button within a relevant user interface, based upon which SBR process 20 may provide an input prompt that may allow the participant to provide an expertise rating.

Although some of the discussion herein may include examples of expertise ratings in the context of requests for assistance, it will be understood that this is not intended to limit the disclosure. For example, SBR process 20 may execute various functionality with respect to a variety of identified 200 electronic communication sessions, which may or may not include specific (or other) requests for assistance. For example, SBR process 20 may usefully receive 208 an expertise rating with respect to an electronic communication session in which no participant specifically sought assistance with respect to a determined 202 subject matter area, but in which various participants offered opinions, assessments, and/or other input relating to the determined 202 subject matter area. For example, SBR process 20 may receive 208 an expertise rating with respect to (and/or from) a presenter or commenter in an online presentation, various individuals participating in an electronic team room brainstorming session, an text-based chat exchange between engineers cooperatively advancing development of a particular product, and so on.

In certain embodiments, SBR process 20 may receive 208 a rating (e.g., a rating may be provided by a rating participant) in the context of the identified 200 electronic communication session (i.e., in the context of an electronic communication session in which the rating participant and the rated participant have both participated with respect to the determined 202 subject matter area). For example, SBR process 20 may receive 208 a rating while the relevant communication session is still active and/or SBR process 20 may receive 208 a rating based upon the termination 212 of a relevant portion of a communication session. For example, in certain embodiments, SBR process 20 may provide 210 a prompt to a rating participant requesting that participant to provide a rating upon identifying that the rating participant has closed a communication window associated with the identified session (e.g., has closed the relevant text-based chat user interface), thereby terminating the relevant communication session. This may be useful, for example, as the termination of a relevant session may be an appropriate time for an individual to provide a rating, given that the relevant interaction may be fresh in the individual's mind, and that providing the rating after the relevant session has terminated (e.g., rather than while the session is ongoing or after another task is likely to have arisen) may allow the individual to focus her full attention of providing the rating.

In certain embodiments, SBR process 20 may provide 210 a prompt to a rating participant requesting that participant to provide a rating upon determining that the discussion within the identified 200 communication session has shifted to a different subject matter area (and thereby identifying that the relevant portion of the session, with respect a particular subject matter area, has terminated 212). For example, a first participant may initiate a communication session in order to request assistance from a second participant with respect to a particular (determined 202) subject matter area and may receive the assistance requested. In certain embodiments, however, the participants may wish to continue the communication session in order to discuss other issues (including, for example, to request and/or provide assistance with regard to various other subject matter areas). In such a case, SBR process 20 may determine 202 (e.g., through semantic analysis 204 or identification 206 of topic keywords) that the discussion has shifted to a new subject matter area. As such, for example, in order to receive 208 an expertise rating with respect to the first-discussed subject matter area while the relevant experience is fresh in the minds of the participants, SBR process 20 may provide 210 a prompt to provide an expertise rating based upon identifying the shift to the new subject matter area (i.e., upon identifying the termination 212 of a relevant portion of the identified 200 session). In certain embodiments, such a prompt may be provided in a relatively unobtrusive way (e.g., as a flashing icon or other unobtrusive animation forming part of a relevant user interface), so as to permit the rating participant to continue to focus on the relevant session to an appropriate degree.

In certain embodiments, SBR process 20 may provide 210 a prompt with one or more pre-selected subject matter areas (e.g., a subject matter area determined 202 based upon identification 206 of relevant topic keywords from the identified 200 communication session). In certain embodiments, SBR process 20 may provide 210 a prompt with a set of subject matter areas from which the rating individual may select one or more subject matter areas with respect to which she intends to provide an expertise rating. In certain embodiments, SBR process 20 may provide 210 a prompt that allows free-form (and/or other) entry of one or more subject matter areas by the rating (and/or another) individual. For example, SBR process 20 may provide 210 a prompt in which a rating individual may type (or otherwise indicate) a particular subject matter area for which she wishes to provide an expertise rating.

In certain embodiments, SBR process 20 may determine 214 an average expertise rating of a rated individual, with respect to one or more determined 202 subject matter areas. For example, it may be useful to determine 214 an average expertise rating based upon a currently received 208 expertise rating as well as various previously-received expertise ratings, in order to give a more universal perspective of the relevant expertise of a rated participant. Such a determined 214 average rating (and/or various received 208 ratings) may be provided, for example, as part of a profile associated with a rated participant. For example, various expertise ratings may be displayed as part of a social networking profile or as part of a company directory profile, and so on.

In certain embodiments, SBR process 20 may determine 214 a weighted average expertise rating of a rated individual, with respect to one or more determined 202 subject matter areas, using various weighting techniques. For example, SBR process 20 may weight received 208 expertise ratings based upon the timing with which the ratings were provided, organizational hierarchy 216 information, expertise ratings 218 associated with relevant rating participants, the frequency of interaction 220 between rated and rating participants, the nature of the relationship between rated and rating participants, and so on. For example, SBR process 20 may assign greater weight to expertise ratings that have been recently received, and which may, accordingly, more accurately reflect the current expertise of the rated participant. Similarly, SBR process 20 may assign greater weight to expertise ratings received 208 from individuals with higher ranking positions in a relevant organizational hierarchy 216, expertise ratings received 208 from rating individuals who themselves have high expertise ratings 218 in the relevant subject matter area, expertise ratings received 208 from rating individuals who have frequently interacted with the rated individuals with respect to the relevant subject matter area, and so on.

In certain embodiments, SBR process 20 may determine 214 an average expertise rating based upon various combinations of expertise ratings that were received 208 in the context of relevant communication sessions and various other expertise ratings (e.g., expertise ratings from yearly performance reviews, and so on), which may, for example, be received by SBR process from various other applications or processes.

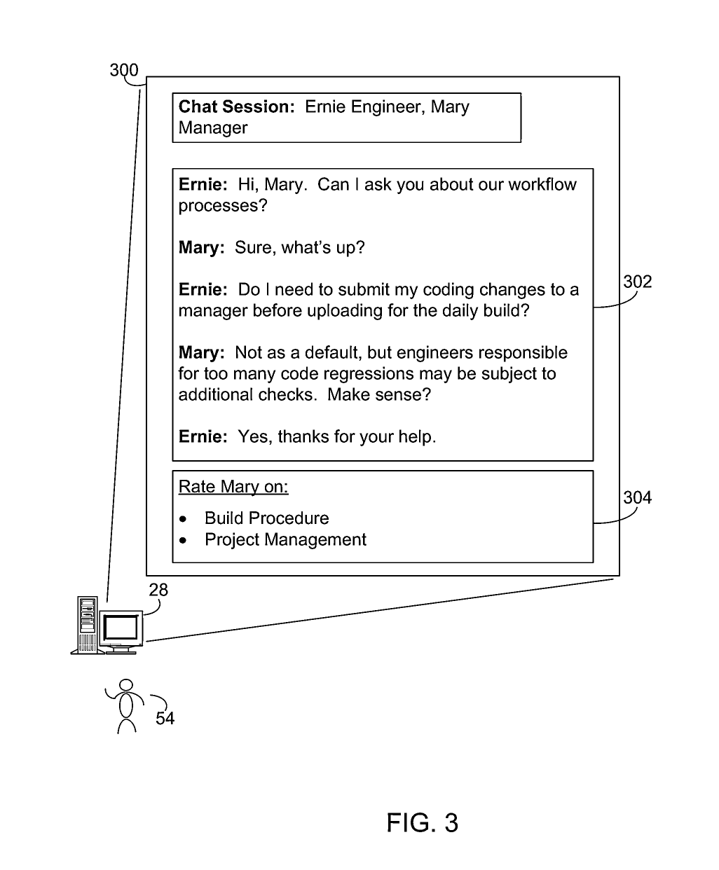

Referring now also to FIG. 3, user 54 (i.e., Ernie Engineer) may initiate a text-based chat session 300 on computing device 28 in order to request assistance from Mary Manager with respect to a software engineering workflow issue. In certain embodiments, for example, SBR process 20 may engage in semantic analysis 204 of the information included in transcript window 302 in order to determine 202 relevant subject matter areas. For example, based upon the introductory phrases such as “Can I ask . . . ,” and “Do I . . . ,” SBR process 20 may determine 202 that Ernie may be requesting assistance with regard to “workflow processes,” “coding changes,” “software builds” and so on. Similarly, based upon identifying 206 topic keywords such as “code regressions” “coding,” “build,” “code regressions” and so on, SBR process 20 may determine 202 additional relevant subject matter areas, such as “Build Procedures” and “Project Management.” As such, upon identifying the termination 212 of a relevant portion of the communication session, SBR process 20 may provide 210 a prompt to Ernie (and/or Mary) to provide one or more relevant expertise ratings. For example, based upon identifying (e.g., based upon semantic analysis 204, and so on) Ernie's requests for assistance, a related response from Mary, and conclusory language from Ernie (i.e., “thanks for your help”), SBR process 20 may determine that a portion of the communication between Ernie and Mary that is relevant to Ernie's requests (and the associated determined 202 subject matter areas) may have terminated 212. Accordingly, SBR process 20 may, for example, provide 210 rating window 304 (and/or another prompt (not shown)) in order to prompt Ernie to provide a rating for Mary with respect to one or more determined 302 subject matter areas.

Although not depicted in FIG. 3, SBR process 20 may similarly provide 210 a prompt to Mary to rate Ernie. Additionally/alternatively, SBR process 20 may provide 210 a prompt to one or more of Mary or Ernie based upon identifying that one (or both) of them has closed the relevant text-based chat window (e.g., window 300) thereby indicating that the identified 200 communication session has terminated.

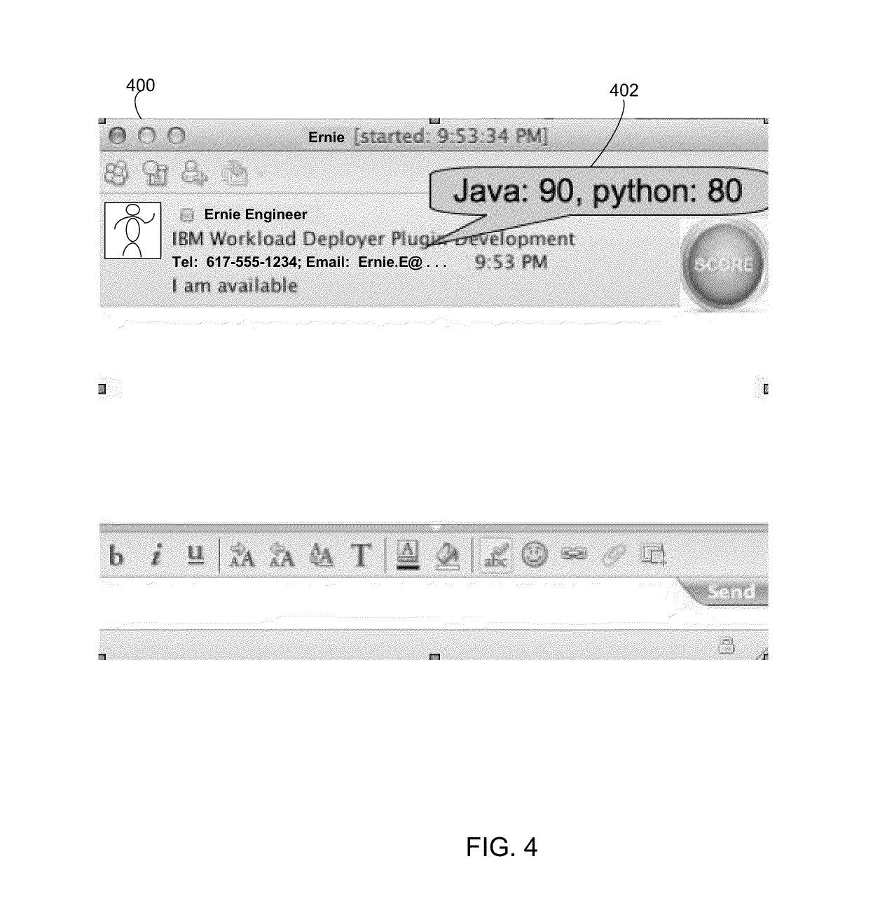

Referring now also to FIG. 4, and as also discussed above, a received 208 rating and/or a determined 214 average rating may be provided as part of a profile of a rated individual (and/or in various other ways). For example, SBR process 20 may have determined 214 for Ernie Engineer an average rating of 90 out of 100 for proficiency with Java, and an average rating of 80 out of 100 for proficiency with Python®. (Python is a registered trademark of Python Software Foundation in the United States, other countries, or both.) Such ratings may be made visible with respect to one or more of Ernie's profiles in various ways. For example, upon an individual mousing over (and/or otherwise selecting) profile information associated with Ernie (e.g., as may be presented in text-based chat window 400), pop-up display 402 of various determined 214 average ratings (and/or other information) may be provided.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of embodiments and implementations have been described. Nevertheless, it will be understood that various modifications may be made. Accordingly, other embodiments and implementations are within the scope of the following claims.

What is claimed is:

1. A computer-implemented method comprising:
identifying, by one or more computing devices, an electronic communication session including a first individual and a second individual;
determining, by the one or more computing devices, a subject matter area associated with the electronic communication session; and
receiving, by the one or more computing devices, a first expertise rating of the first individual by the second individual with respect to the subject matter area, the first expertise rating being provided in the context of the electronic communication session.

2. The computer-implemented method of claim 1 further comprising:
providing a prompt to the second individual to provide the first expertise rating based upon, at least in part, identifying a termination of a portion of the electronic communication session relating to the subject matter area.

3. The computer-implemented method of claim 1 wherein the subject matter area is determined based upon, at least in part, semantic analysis of an aspect of the electronic communication session.

4. The computer-implemented method of claim 1 wherein the subject matter area is determined based upon, at least in part, identifying one or more topic keywords associated with the electronic communication session.

5. The computer-implemented method of claim 1 further comprising:
determining an average expertise rating of the first individual based upon, at least in part, the first expertise rating and one or more additional expertise ratings associated with the subject matter area and the first individual.

6. The computer-implemented method of claim 5 wherein the average expertise rating is a weighted average determined based upon, at least in part, weighting the received first expertise rating based upon, at least in part, one or more of an organizational hierarchy, an expertise rating of the second individual with respect to the subject matter area, and a frequency of interaction between the first and second individuals with respect to the subject matter area.

7. The computer-implemented method of claim 1 further comprising:
receiving a second expertise rating of the second individual by the first individual with respect to the subject matter area, the second expertise rating being provided in the context of the electronic communication session.

8. A computer program product residing on a non-transitory computer-readable storage medium having a plurality of instructions stored thereon, which, when executed by a processor, cause the processor to perform operations comprising:
identifying an electronic communication session including a first individual and a second individual;
determining a subject matter area associated with the electronic communication session; and
receiving a first expertise rating of the first individual by the second individual with respect to the subject matter area, the first expertise rating being provided in the context of the electronic communication session.

9. The computer program product of claim 8 wherein the operations further comprise:
providing a prompt to the second individual to provide the first expertise rating based upon, at least in part, identifying a termination of a portion of the electronic communication session relating to the subject matter area.

10. The computer program product of claim 8 wherein the subject matter area is determined based upon, at least in part, semantic analysis of an aspect of the electronic communication session.

11. The computer program product of claim 8 wherein the subject matter area is determined based upon, at least in part, identifying one or more topic keywords associated with the electronic communication session.

12. The computer program product of claim 8 wherein the operations further comprise:
determining an average expertise rating of the first individual based upon, at least in part, the first expertise rating and one or more additional expertise ratings associated with the subject matter area and the first individual.

13. The computer program product of claim 12 wherein the average expertise rating is a weighted average determined based upon, at least in part, weighting the received first expertise rating based upon, at least in part, one or more of an organizational hierarchy, an expertise rating of the second individual with respect to the subject matter area, and a frequency of interaction between the first and second individuals with respect to the subject matter area.

14. The computer program product of claim 8 wherein the operations further comprise:
receiving a second expertise rating of the second individual by the first individual with respect to the subject matter area, the second expertise rating being provided in the context of the electronic communication session.

15. A computer system comprising:
one or more processor devices; and
one or more memory architectures coupled with the one or more processor devices;
wherein the one or more processor devices are configured to:
identify an electronic communication session including a first individual and a second individual;
determine a subject matter area associated with the electronic communication session; and
receive a first expertise rating of the first individual by the second individual with respect to the subject matter area, the first expertise rating being provided in the context of the electronic communication session.

16. The computer system of claim 15 wherein the one or more processor devices are further configured to:
provide a prompt to the second individual to provide the first expertise rating based upon, at least in part, identifying a termination of a portion of the electronic communication session relating to the subject matter area.

17. The computer system of claim 15 wherein the subject matter area is determined based upon, at least in part, one or more of semantic analysis of an aspect of the electronic communication session and identifying one or more topic keywords associated with the electronic communication session.

18. The computer system of claim 15 wherein the one or more processor devices are further configured to:
determine an average expertise rating of the first individual based upon, at least in part, the first expertise rating and one or more additional expertise ratings associated with the subject matter area and the first individual.

19. The computer system of claim 18 wherein the average expertise rating is a weighted average determined based upon, at least in part, weighting the received first expertise rating based upon, at least in part, one or more of an organizational hierarchy, an expertise rating of the second individual with respect to the subject matter area, and a frequency of interaction between the first and second individuals with respect to the subject matter area.

20. The computer system of claim 15 wherein the one or more processor devices are further configured to:
receive a second expertise rating of the second individual by the first individual with respect to the subject matter area, the second expertise rating being provided in the context of the electronic communication session.
